(19) United States
(12) Patent Application Publication
(10) Pub. No.: US 2020/0385031 A1
(43) Pub. Date: Dec. 10, 2020

(54) RETENTION AND GUIDE ASSEMBLY FOR A VEHICLE DOOR

(71) Applicant: Westinghouse Air Brake Technologies Corporation, Wilmerding, PA (US)

(72) Inventors: Frédéric Augé, Outremont (CA); Luc Vachon, Verdun (CA)

(21) Appl. No.: 16/894,299

(22) Filed: Jun. 5, 2020

Related U.S. Application Data
(60) Provisional application No. 62/858,581, filed on Jun. 7, 2019.

(51) Int. Cl. B61D 19/00; E05D 15/08; E05D 15/10; E05F 17/00; E05F 15/56

(52) U.S. Cl. CPC B61D 19/005; E05D 15/08; E05D 15/1042; E05D 15/1068; E05F 17/004; E05Y 2900/51; E05D 2015/1071; E05Y 2201/238; E05Y 2201/24; E05Y 2800/264; E05F 15/565

(57) ABSTRACT

A retention and guide assembly for a vehicle door includes a guide track connected to a door panel of the vehicle door. The guide track includes sidewalls that at least partially extend around and define an internal recessed volume. The sidewalls include a first sidewall coupled with the door panel and a second sidewall coupled with and oriented transverse to the first sidewall. The guide track includes a retaining flange that is coupled with and oriented transverse to the second sidewall. The sidewalls and the retaining flange are shaped to receive (within the internal recessed volume) a roller of a control arm extending from a vehicle body. The retaining flange engages the control arm and/or the roller and retain the roller within the internal recessed volume of the guide track between the second sidewall and the door panel of the vehicle door.

### CROSS-REFERENCE TO RELATED APPLICATIONS

This application claims priority to U.S. Provisional Application No. 62/858,581, which was filed on 7 Jun. 2019, and the entire disclosure of which is incorporated herein by reference.

### BACKGROUND

### Technical Field

The subject matter described herein relates to a guide structure for opening and closing a vehicle door.

### State of the Art

A sliding or sliding plug door for a vehicle, particularly a transit vehicle such as a passenger railcar or bus, usually includes a guide track or rail at the bottom of the door leaf or panel into which a roller is inserted to retain the door panel along the inboard-outboard direction and to guide the motion of the door panel between the open and closed positions. FIG. 1 shows such an arrangement implemented with an ‘L’ profile guide track 100. The roller is behind the guide track and not visible in FIG. 1, but is coupled with a swing arm 102. Under severe operating conditions (shocks, impacts, vandalism) causing a change in the relative position of the roller with respect to the guide track along a vertical axis 104, or consequent to a defective installation, the roller may disengage from the guide track without being detected. This becomes a safety hazard because the lower part of the door panel that is coupled with the swing arm is no longer retained, allowing potential accidents such as a passenger falling on the wayside of the vehicle. Additionally, this becomes a latent defect due to the non-detection of this hazard.

Current solutions to the problems of preventing disengagement of the vehicle panel involve non-encapsulated intrusive assemblies that are positioned in functional areas where they can create other types of issues with surrounding components, such as internal door trimming and external car shell skirt. These solutions are also expensive, not easy to retrofit on a revenue service fleet, unsightly, and visible by passengers so that they might attract attention and invite to tampering. Moreover, existing systems do not allow immediate detection of roller disengagement, which makes the hazard dormant and unnoticed.

Most existing systems or assemblies for retaining the door panel include a protuberant stopper 200 disposed on the lower part of a coordination bar 202 or control arm 204 extending from the vehicle and a rail or bent bracket 206 affixed to the door panel as shown in FIG. 2. Such systems require the fastening of an additional shoulder or bracket on the door panel, which must be installed within a limited area to avoid taking up too much space and avoid interfering with surrounding vehicle components when the door is in motion. Consequently, these existing systems or assemblies affect two components: the roller/control arm extending from the vehicle and the door panel, which must be drilled at right angle to its main plane to fasten the bracket. This potentially creates issues of mounting hardware retention and water ingress into the interior core of the door panel structure. Moreover, none of the existing systems allow for detection of a misplacement of the roller/control arm with respect to the guide track.

### BRIEF SUMMARY

In one embodiment, a retention and guide assembly for a vehicle door is provided. The assembly includes a guide track configured to be connected to a door panel of the vehicle door. The guide track includes sidewalls that at least partially extend around and define an internal recessed volume. The sidewalls include a first sidewall configured to be coupled with the door panel and a second sidewall that is coupled with and oriented transverse to the first sidewall. The guide track includes a retaining flange that is coupled with and oriented transverse to the second sidewall. The sidewalls and the retaining flange are shaped to receive (within the internal recessed volume) a roller of a control arm extending from a vehicle body. The retaining flange is configured to engage one or more of the control arm or the roller and retain the roller within the internal recessed volume of the guide track between the second sidewall and the door panel of the vehicle door.

Another example of a vehicle door retention and guide assembly includes an elongated first sidewall configured to be connected to a door panel of a vehicle door, an elongated second sidewall coupled with and oriented transverse to the first sidewall, and an elongated retaining flange coupled with and oriented transverse to the second sidewall. Each of the first sidewall, the second sidewall, and the retaining flange extends from a first end toward a second end. The first and second sidewalls extend from the first end to the second end. The retaining flange extends from the first end toward, but not entirely to, the second end. The first sidewall, the second sidewall, and the retaining flange at least partially extend around and bounding an internal recessed volume. The first sidewall, the second sidewall, and the retaining flange are shaped to receive a roller of a control arm extending from a vehicle body between the first sidewall, the second sidewall, and the retaining flange. The retaining flange is positioned to engage one or more of the control arm or the roller and retain the roller within the internal recessed volume between the second sidewall and the door panel of the vehicle door.

Another example of a retention and guide assembly for a vehicle door includes a guide track configured to be connected to a door panel of the vehicle door. The guide track includes sidewalls and an extension flange that at least partially extend around and define an internal recessed volume. The sidewalls include a first sidewall configured to be coupled with the door panel, a second sidewall that is coupled with and oriented transverse to the first sidewall and disposed away from the door panel, and a third sidewall that is coupled with and oriented transverse to the first sidewall and disposed to rest against a plane of the door panel. The extension flange is configured to be coupled with and oriented transverse to the third sidewall. The sidewalls and the extension flange are shaped to receive, within the internal recessed volume, a roller of a control arm extending from a vehicle body between the sidewalls and the extension flange. The extension flange is configured to engage the control arm and retain the roller within the internal recessed volume of the guide track between the second sidewall and the door panel of the vehicle door.

### BRIEF DESCRIPTION OF THE DRAWINGS

The inventive subject matter may be understood from reading the following description of non-limiting embodiments, with reference to the attached drawings, wherein below:

FIG. 1 illustrates an ‘L’ profile guide track;

FIG. 2 illustrates a protuberant stopper disposed on a lower part of a coordination bar and a control arm extending from a vehicle and a rail or bent bracket affixed to a door panel;

FIGS. 3 and 4 are general views of a first embodiment of the inventive subject matter with the door closed (FIG. 3) and the door open (FIG. 4)

FIGS. 5 and 6 are perspective views of a guide track of the assembly shown in FIGS. 3, 4, and 7;

FIG. 7 is a cross-sectional view of a retention and guide assembly according to one example;

FIG. 8 is a cross-sectional view of the assembly shown in FIG. 1 with an addition of a shoulder on a roller shaft shown in FIG. 1; and

FIG. 9 is a cross-sectional view of a retention and guide assembly according to another example.

### DETAILED DESCRIPTION

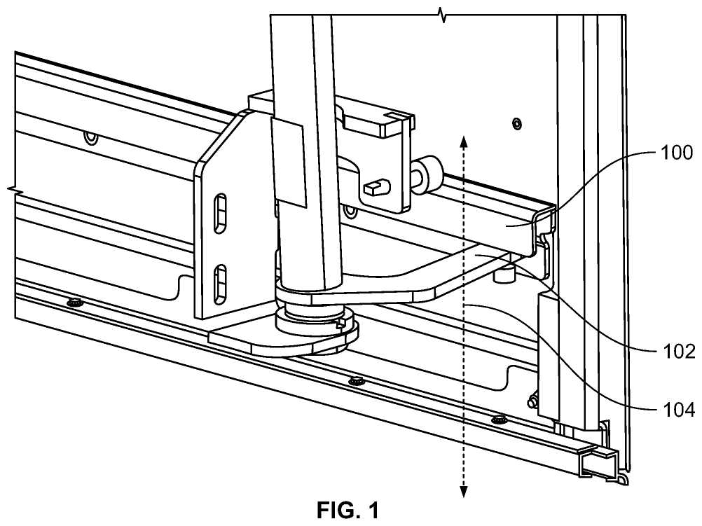

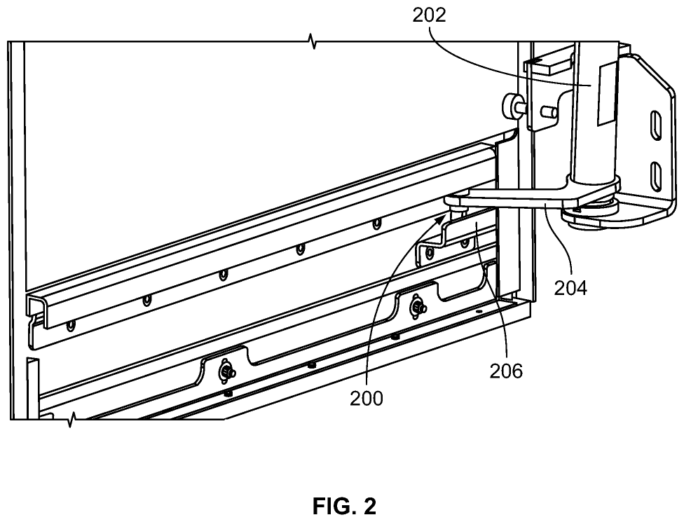

The inventive subject matter described herein provides a retention and guide assembly that implements a connection between a vehicle door panel and a control arm extending from a vehicle through a roller. The assembly can prevent disengagement of the roller from the door panel-mounted guide track under severe conditions of shock and vibrations having a substantial vertical component. The assembly can allow for detection of a partial or complete disengagement of the vehicle door panel from the roller and/or the control arm by incorporating a device such as a sensitive edge, a piezoelectric strip, a magnetic switch, or the like. The assembly can integrate the retention and detection functions into an encapsulated area close to the door panel, thereby limiting accessibility to passengers and therefore the potential for vandalism. In particular, the retention device can be mounted inside the guide track so as to be hidden from passengers, preventing or limiting any false activation that may be due to tampering. The assembly may be easily retrofittable on existing fleets of vehicles because the assembly may only involve a single component replacement with a torque tightening process. As one example, the ‘L’ profile guide track shown in FIG. 1 can be replaced by the inventive guide track described herein and use the same mounting points to the door panel as the ‘L’ profile guide track.

According to one example, the assembly includes a guide track configured to be connected to a door panel of the vehicle door. The door panel and the guide track sidewalls define an internal recessed area configured to receive a roller mounted on a control arm connected to a vehicle body. The guide track incorporates a retaining flange that partially encloses the internal recessed area and is configured to engage the control arm and/or the roller to retain the roller in the internal recessed area.

According to another example, the guide track may comprise an extension flange (not to be confused with the retaining flange) defining a substantially horizontal lower sidewall of the guide track. The extension flange is configured (i.e. shaped, sized, and/or positioned) to engage the control arm lower surface to retain the roller in the internal recessed area of the guide track.

The guide track may comprise a cutout portion along the length of the guide track in which the retaining flange or the extension flange) is removed to allow the roller to be inserted into the internal recessed area of the guide track. The assembly may further include a shoulder configured to be disposed on a roller shaft of the roller and to provide a retention contact surface to abut the retaining flange.

The assembly may include a detection device disposed on the guide track. The detection device can detect a partial or complete disengagement of the roller and/or the control arm from the guide track. The detection device may be disposed on the retaining flange. The detection device may comprise a sensitive edge, a piezoelectric strip, and/or a magnetic switch (direct detection), or alternatively a rubber friction strip (indirect detection through overcurrent monitoring detection). The detection device may be configured to communicate with a door control unit of the vehicle to provide a signal to the door control unit regarding a partial or complete disengagement of the roller and/or the control arm from the guide track. One embodiment of detection device allows for positively signaling that the roller is properly engaged in the recessed area. The absence of signal or a signal out of bound would then indicate a fault.

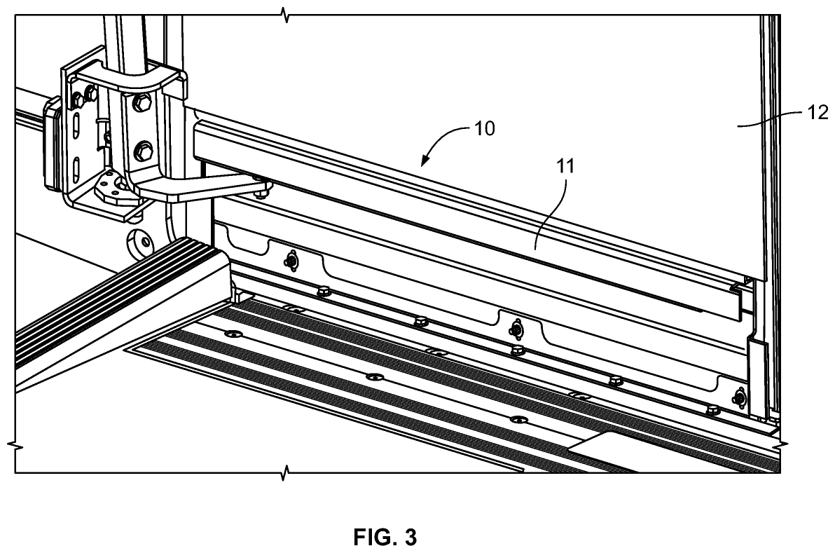

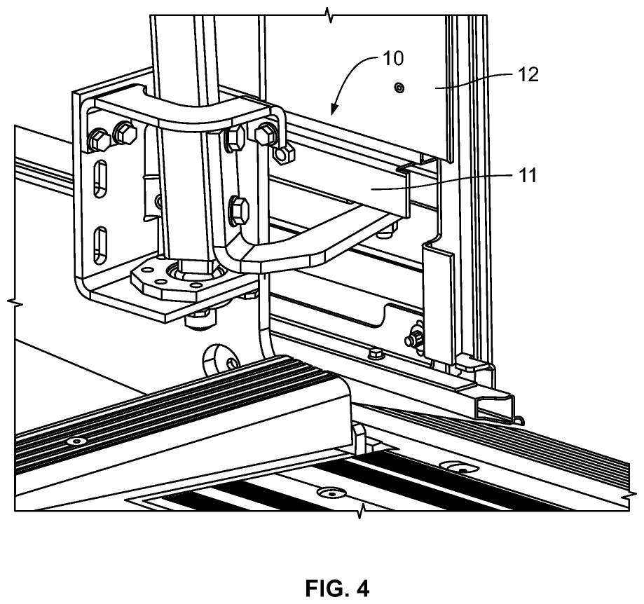

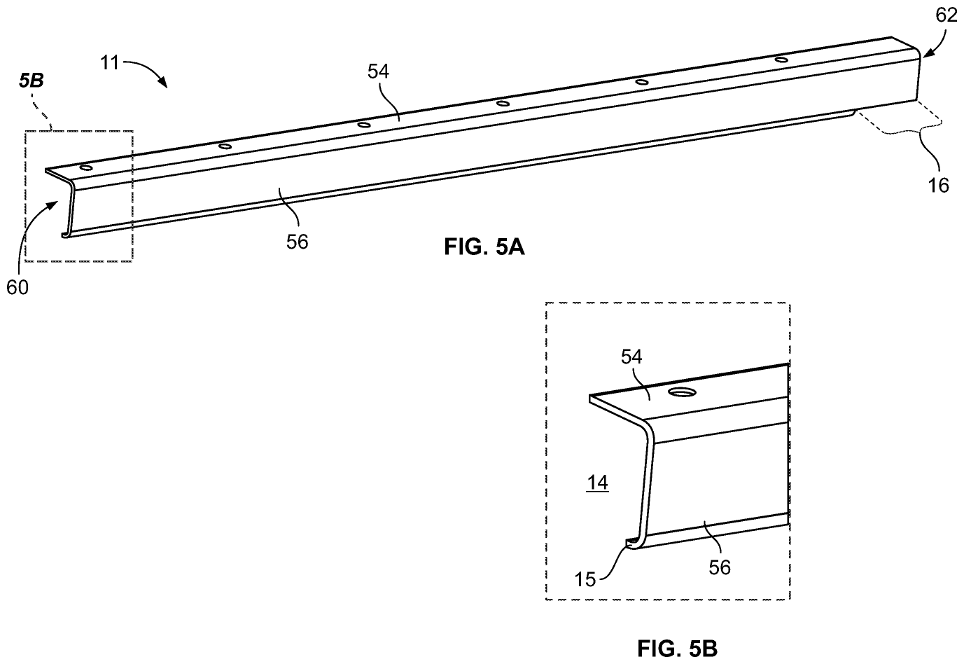

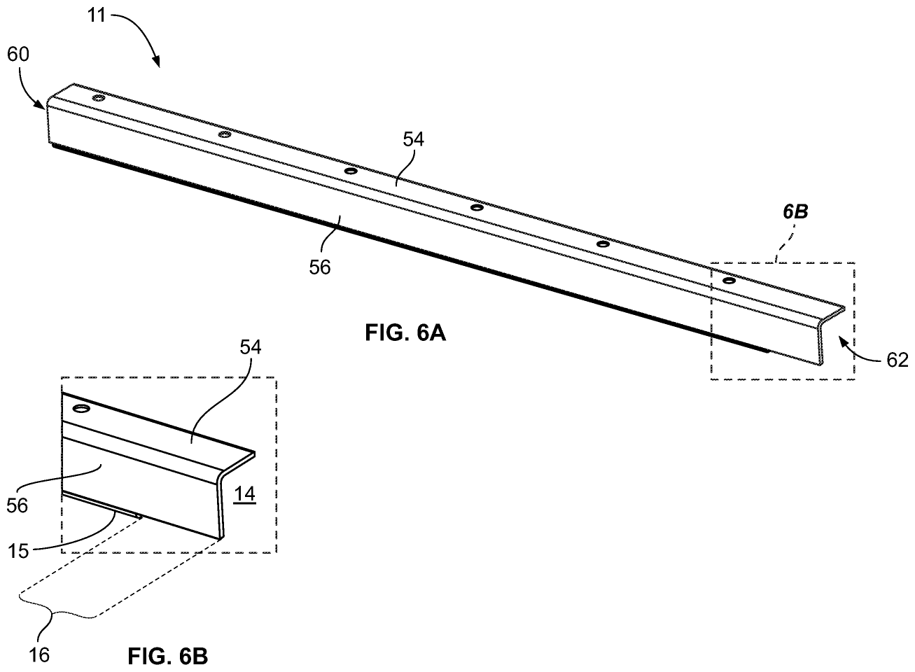

FIG. 3 illustrates a first embodiment of a retention and guide assembly 10 with a vehicle door panel 12 closed. FIG. 4 illustrates the retention and guide assembly shown in FIG. 3 with the vehicle door open. The vehicle door may be a sliding door, a sliding and plugging door, a hinged pivoting door, or a pivoting/sliding door provided for passenger ingress/egress on a vehicle, such as a transit vehicle (e.g., a passenger bus, subway car, trolley car, other rail transit vehicle, or similar vehicle). Optionally, the assembly may be used in connection with a door of another type of vehicle or a door that is not included in a vehicle. The assembly includes a guide track 11 that also is shown in FIGS. 5 and 6. With continued reference to FIGS. 3 and 4, FIG. 5 illustrates a perspective view of one example of the guide track shown in FIGS. 3 and 4. FIG. 6 illustrates a different perspective view of the guide track shown in FIGS. 3 through 5. The assembly 10 includes the guide track 11 connected to the vehicle door or vehicle door panel 12. The guide track 11 may be in the form of an extruded or bent channel member including a number of sidewalls 54, 56, along with a retaining flange 15, that define or partially extend around an internal recessed area or volume 14.

Each of the sidewalls 54, and the retaining flange 15 may extend in a different two-dimensional plane with the planes being parallel or substantially parallel to each other. For example, these planes may be within five degrees of being parallel to each other, within three degrees of parallel to each other, or within 1 degree of being parallel to each other in different embodiments. The sidewall 56 may extend in a third two-dimensional plane that is transverse (e.g., perpendicular or substantially perpendicular) to the sidewall 54 and the retaining flange 15. For example, the sidewall 56 may extend in plane that is within five degrees of being perpendicular to the planes of the sidewall 54 and the retaining flange 15, within three degrees of being perpendicular to the planes of the sidewall 54 and the retaining flange 15, or within 1 degree of being perpendicular to the planes of the sidewall 54 and the retaining flange 15 in different embodiments. As shown in FIGS. 5 and 6, the sidewall 56 extends from the retaining flange 15 to the sidewall 54 such that the sidewall 56 interconnects the sidewall 54 to the retaining flange 15. The guide track 11 is elongated from a first end 60 to an opposite, second end 62, and has a length extending from the end 60 to the end 62. The sidewalls 54, 56 have a greater length than the retaining flange 15 in that each of the sidewalls 54, 56 extends from the end 60 to the end 62, while the retaining flange 15 partially extends from the end 60 toward, but not entirely to, the end 62. Alternatively, the flange 15 may extend further along the length of the guide track 11 or may extend a shorter distance along the length of the guide track 11.

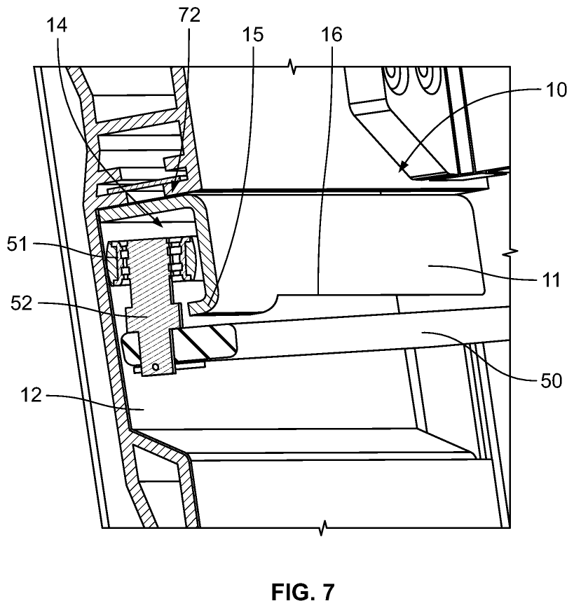

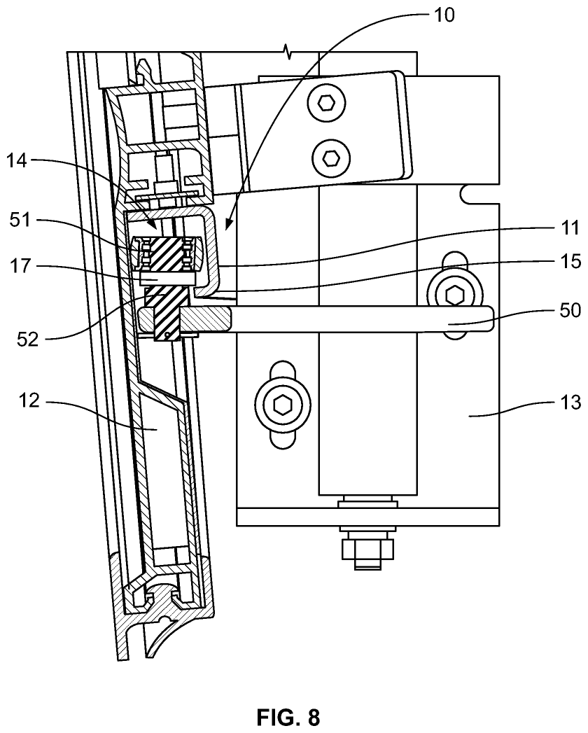

FIGS. 7 and 8 illustrate cross-sectional views of the assembly shown in FIGS. 3 and 4. The door frame 12 may have a horizontal ledge or extension 72 to which the guide track 11 is coupled. The sidewall 54 may be coupled to this ledge 72. For example, one or more fasteners may affix the sidewall 54 to the ledge 72 such that the sidewall 56 vertically extends and projects in a plane substantially parallel to the vehicle door frame 12. As shown in FIG. 1, the sidewall 56 may extend downward and the retaining flange 15 may extend toward the door frame 12.

The recessed area or volume 14 is shaped and sized to receive a roller 51 connected to a vehicle body 13 through a control arm 50 for guiding the door panel 12 as the door panel 12 moves between open and closed positions and to restrict the door panel inboard-outboard movement. For example, the roller 51 may roll or otherwise move within the area or volume 14 along the length of the guide track 11 as the door panel 12 moves between open and closed positions.

The roller 51 is rotatably disposed on a roller shaft 52 provided on a control arm 50 extending from the vehicle body. According to one example, the control arm 50 may be a coordination bar, a swing arm, a roller arm, or any other type of similar arm or retaining structure.

The guide track 11 includes a retaining flange 15 that may be formed by a bend of the sidewall 56. The retaining flange 15 partially encloses the internal recessed area or volume 14 of the guide track 11. For example, the retaining flange 15 may project from the sidewall 56 toward the door panel 12 such that the roller 51 is bounded and confined between the door panel 12 and the sidewalls 56, 58, and the retaining flange 15. The roller 51 may contact and roll along one or more of the door panel surface 12 and the sidewall 56 during opening or closing of the door.

The retaining flange 15 is positioned to engage the roller 51 to retain the roller 51 in the internal recessed area or volume 14 and thereby may prevent or limit disengagement of the roller 51 from the guide track 11. The retaining flange 15 operates as mechanical stop that may engage the roller 51 or some other structure associated with the roller 51 to prevent or limit the roller 51 from being pulled out of the internal recessed area or volume 14 and disengaging from the guide track 11. For example, the retaining flange 15 extends below the roller 51 such that the space between the edge of the retaining flange 15 and the door panel 12 is narrower than the width of the roller 51. This prevents the roller 51 from exiting the internal area or volume 14 from between the flange 15 and the door panel 12.

The guide track 11 may include a cutout portion 16 extending partially along the length of the guide track 11. The cutout portion 16 represents an opening created by the section or portion of the length of the guide track 11 that does not include the retaining flange 15. This cutout portion allows the roller 51 and the roller shaft 52 to be inserted into the internal recessed area or volume 14 of the guide track 11. For example, the roller 51 and roller shaft 52 may be received into the area or volume 14 through the portion of the length of the guide track 11 where the retaining flange 15 is retained. A separate cover may be provided for fastening on the guide track 11 over the length of the guide track 11 where the retaining flange 15 is not present in the event that this portion of the length of the guide track 11 is positioned in the usual in-service path of the roller 51 during the open/close movement of the door panel 12. Alternatively, this portion of the length of the guide track 11 may be positioned at one or both ends of the guide track 11, outside the usual in-service path of the roller 51, but yet accessible by the roller for insertion in the recessed area during installation of the door. For this purpose, the guide track 11 may be lengthened to position the cutout portion 16 in an area retaining flange 15 outside the usual in-service path of the roller 51.

As shown in FIG. 8, the assembly 10 may further include a shoulder 17 that is disposed on the roller shaft 52 between the roller 51 and the retaining flange 15. The shaft 52 may be a cylindrical body or post around which the roller 51 rotates. The shoulder 17 is a portion of the shaft that radially projects from the shaft axis and provides a retention contact surface to abut the retaining flange 15. Accordingly, the shoulder 17 can provide a direct retention contact surface for engaging the retaining flange 15 so that the retaining flange 15 does not apply a direct force or pressure against the roller 51 and any of components (such as a bearing dust cap or other cover used to keep lubrication inside the roller and/or provide protection from dust) when the roller 51 is pulled toward the retaining flange 15.

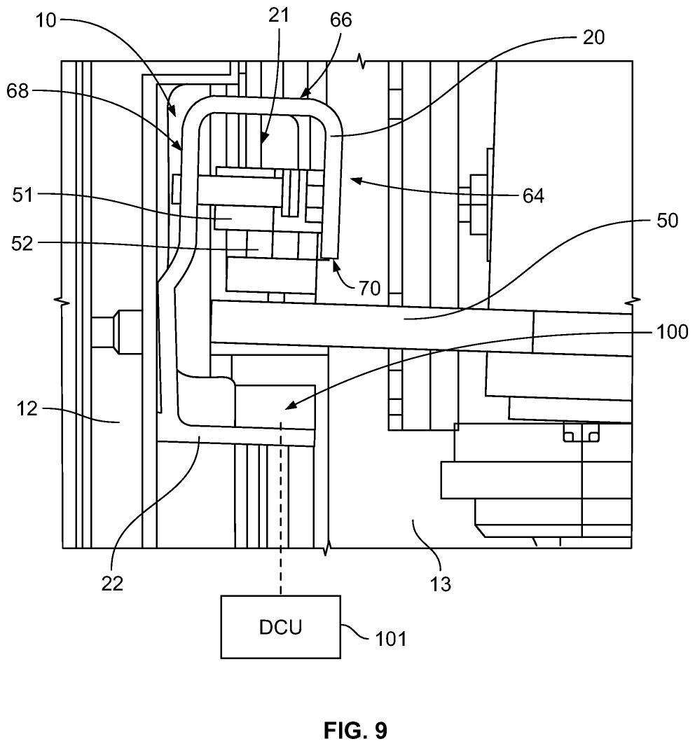

FIG. 9 illustrates another example of the retention and guide assembly 10. According to this example, the guide assembly 10 includes a guide track 20 connected to the door panel 12 of the vehicle door. The guide track 20 may be in the form of an extruded or bent channel member including a number of sidewalls 64, 66, 68 that define or at least partially extend around an internal recessed area or volume 21. The sidewalls 64, 68 may be parallel or substantially parallel to each other and transverse (e.g., perpendicular or substantially perpendicular) to the sidewall 66. The area or volume 21 receives the roller 51 that is connected to the vehicle body 13 for guiding the door panel 12 as the door panel 12 moves between open and closed positions and for retaining the door panel 12 on the vehicle body 13. For example, the roller 51 may move or roll along the length of the guide track 20 (e.g., into and out of the plane of FIG. 4) as the door panel 12 moves between open and closed positions. The guide track 20 includes an extension flange 22 located at the base of the guide track 20. The extension flange 22 optionally can be another sidewall of the guide track 20. The extension flange 22 can be a cantilevered wall that is coupled with the sidewall 68. The extension flange 22 can be substantially parallel to the sidewall 66 and substantially transverse (e.g., perpendicular) to sidewalls 64, 68. The extension flange 22 can extend beneath the sidewall 64 such that a gap or open space exists between (a) a lower edge or tip 70 of the sidewall 64 that faces a control arm 50 and (b) the extension flange 22. The extension flange 22 is positioned to engage the control arm 50 to retain the roller 51 in the internal recessed area 21 of the guide track 20. Accordingly, the extension flange 22 acts as mechanical stop that may engage the control arm 50 to prevent or limit the control arm 50 from being pulled out of or disengaged from the recessed area 21. In this embodiment, the extension flange 22 has a function similar to the retaining flange 15 of the embodiment shown in FIGS. 3 through 8.

As shown in FIG. 9, the retention and guide assembly 10 may also include a detection device or sensor 103 disposed on the extension flange 22 of the guide track 20 and oriented toward the control arm 50 and the internal recessed area 21. The detection device 103 is positioned and configured to detect a partial or complete disengagement of the roller 51 and/or the control arm 50 from the guide track 20. In particular, the detection device 103 may incorporate a proximity or contact sensor that generates a signal responsive to the control arm 50 and/or the roller 51 position with respect to the guide track 20. According to an example, the detection device 103 may include a sensitive edge (rubber sensitive edge), a piezoelectric strip, a capacitive or inductive proximity sensor, and/or a magnetic switch. According to another example, the detection device 103 may include a friction surface that creates an increase of required door panel motive force during door opening/closing, which in turn is detected by the Door Control Unit (DCU) in the form of an increase in required power delivered to the door actuator.

The detection device 103 may be in communication with a door control unit (DCU) 101 of the vehicle and may provide a signal to the door control unit 101 indicating a partial or complete disengagement of the roller 51 and/or the control arm 50 from the guide track 20 so as to warn the vehicle operator or maintenance personnel that the door panel 12 may be partially or completely disengaged from the vehicle body 13. In the event of an overly low position of the control arm 50, a contact and/or an abnormal proximity/small magnetic gap between the control arm 50 and the detection device 100 will result in the detection device generating a signal to the door control unit 101 indicating that the door panel 12 is partially or completely disengaged from the vehicle body 13. The detection device 103 may be positioned on different portions of the guide track 20 than the extension flange 22.

According to an example, the guide track 11, 20 may be formed from a bent metal sheet or an extrusion. According to another example, the retention and guide assembly 10 may be implemented in connection with a roller 51 and control arm 50 positioned at the bottom and/or the top of the vehicle door.

The assembly 10 can be an easy and inexpensive addition to existing vehicle doors as the assembly 10, in certain examples, may only require the addition of a single component to the vehicle door. The assembly 10 may provide a universal solution with a standardized design and key scaled dimensions that can be implemented irrespective of the available clearance between the control arm 50, the roller 51, and the lower ledge 72 of the vehicle door panel 12. The assembly 10 provides for easy implementation of the detection device 100, which can be embedded directly on the flange 15, 22 of the guide track 11, 20. The implementation and positioning of the detection device 103 may allow for faster and more accurate detection of a partial or complete disengagement of the vehicle door, which improves overall safety. The assembly 10 may offer aesthetic benefits due to being less visible to passengers. The assembly 10 may also be less accessible to passengers, which may limit or prevent vandalism and provides additional guard against abuse including false activation of the detection device 103. The assembly 10 may provide a shield or barrier for protecting the roller 51 and the detection device 103 from environmental conditions, such as sunlight, cleaning products and solutions, dirt and moisture, sand and salt abrasion, and other corrosive elements. The assembly 10 may provide a more compact solution by avoiding the necessity to make additional space through cuts on the door panel 12, such as trimming, to allow unobstructed movement of the control arm 50.

In one example, a retention and guide assembly for a vehicle door is provided. The assembly includes a guide track configured to be connected to a door panel of the vehicle door. The guide track includes sidewalls that at least partially extend around and define an internal recessed volume. The sidewalls include a first sidewall configured to be coupled with the door panel and a second sidewall that is coupled with and oriented transverse to the first sidewall. The guide track includes a retaining flange that is coupled with and oriented transverse to the second sidewall. The sidewalls and the retaining flange are shaped to receive (within the internal recessed volume) a roller of a control arm extending from a vehicle body. The retaining flange is configured to engage one or more of the control arm or the roller and retain the roller within the internal recessed volume of the guide track between the second sidewall and the door panel of the vehicle door.

Optionally, the first sidewall of the guide track is configured to be connected to the door panel such that the second sidewall is oriented substantially parallel to a plane of the door panel and the retaining flange projects toward the door panel. The retaining flange can be spaced apart from the door panel while the guide track is connected with the door panel such that a roller shaft on which the roller is disposed is positioned between the door panel and the retaining flange. The guide track can be elongated from a first end toward an opposite second end, with the first and second sidewalls extending from the first end to the second end and the retaining flange extending from the first end partially toward but not to the second end. The retaining flange can partially extend toward the second end and can provide an opening through which the roller is inserted into the internal recessed volume of the guide track. The retaining flange can be positioned to engage a shoulder on a roller shaft on which the roller is disposed, the shoulder disposed between the control arm and the roller.

The assembly optionally can include a sensor coupled with the guide track and that is configured to detect at least a partial disengagement or mis-adjustment during installation or maintenance of one or more of the roller or the control arm from the guide track. The sensor can be coupled with the retaining flange of the guide track. The sensor can include one or more of a piezoelectric strip, a magnetic switch, a capacitive or inductive proximity sensor, a friction strip, and/or a rubber sensitive edge extrusion.

Another example of a vehicle door retention and guide assembly includes an elongated first sidewall configured to be connected to a door panel of a vehicle door, an elongated second sidewall coupled with and oriented transverse to the first sidewall, and an elongated retaining flange coupled with and oriented transverse to the second sidewall. Each of the first sidewall, the second sidewall, and the retaining flange extends from a first end toward a second end. The first and second sidewalls extend from the first end to the second end. The retaining flange extends from the first end toward, but not entirely to, the second end. The first sidewall, the second sidewall, and the retaining flange at least partially extend around and bounding an internal recessed volume. The first sidewall, the second sidewall, and the retaining flange are shaped to receive a roller of a control arm extending from a vehicle body between the first sidewall, the second sidewall, and the retaining flange. The retaining flange is positioned to engage one or more of the control arm or the roller and retain the roller within the internal recessed volume between the second sidewall and the door panel of the vehicle door.

Optionally, the first sidewall is configured to be connected to the door panel such that the second sidewall is oriented substantially parallel to a plane of the door panel and the retaining flange projects toward the door panel. The retaining flange can be spaced apart from the door panel while the first sidewall is connected with the door panel such that a roller shaft on which the roller is disposed is positioned between the door panel and the retaining flange.

Another example of a retention and guide assembly for a vehicle door includes a guide track configured to be connected to a door panel of the vehicle door. The guide track includes sidewalls and an extension flange that at least partially extend around and define an internal recessed volume. The sidewalls include a first sidewall configured to be coupled with the door panel, a second sidewall that is coupled with and oriented transverse to the first sidewall and disposed away from the door panel, and a third sidewall that is coupled with and oriented transverse to the first sidewall and disposed to rest against a plane of the door panel. The extension flange is configured to be coupled with and oriented transverse to the third sidewall. The sidewalls and the extension flange are shaped to receive, within the internal recessed volume, a roller of a control arm extending from a vehicle body between the sidewalls and the extension flange. The extension flange is configured to engage the control arm and retain the roller within the internal recessed volume of the guide track between the second sidewall and the door panel of the vehicle door.

Optionally, the first sidewall of the guide track is configured to be connected to the door panel such that the second and third sidewalls are oriented substantially parallel to the door panel plane and the extension flange projects away from the door panel. The extension flange can be spaced apart from a lower tip of the second sidewall while the guide track is connected with the door panel such that a control arm on which the roller shaft and roller are disposed is positioned between the lower tip of the second sidewall and the extension flange.

The guide track can be elongated from a first end toward an opposite second end. The first, second and third sidewalls extend from the first end to the second end. The extension flange extends from the first end partially toward but not completely to the second end. The extension flange partially extends toward the second end to provide an opening through which the roller is inserted into the internal recessed volume of the guide track.

The assembly optionally can include a sensor coupled with the guide track and configured to detect at least a partial disengagement of one or more of the roller or the control arm from the guide track. The sensor is coupled with the extension flange of the guide track. The sensor can include one or more of a piezoelectric strip, a magnetic switch, a capacitive or inductive proximity sensor, and/or a friction strip.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A retention and guide assembly for a vehicle door, the assembly comprising:
a guide track configured to be connected to a door panel of the vehicle door, the guide track comprising sidewalls that at least partially extend around and define an internal recessed volume, the sidewalls including a first sidewall configured to be coupled with the door panel and a second sidewall that is coupled with and oriented transverse to the first sidewall, the guide track including a retaining flange that is coupled with and oriented transverse to the second sidewall,
the sidewalls and the retaining flange are shaped to receive, within the internal recessed volume, a roller of a control arm extending from a vehicle body, the retaining flange configured to engage one or more of the control arm or the roller and retain the roller within the internal recessed volume of the guide track between the second sidewall and the door panel of the vehicle door.

2. The retention and guide assembly of claim 1, wherein the first sidewall of the guide track is configured to be connected to the door panel such that the second sidewall is oriented substantially parallel to a plane of the door panel and the retaining flange projects toward the door panel.

3. The retention and guide assembly of claim 1, wherein the retaining flange is spaced apart from the door panel while the guide track is connected with the door panel such that a roller shaft on which the roller is disposed is positioned between the door panel and the retaining flange.

4. The retention guide assembly of claim 1, wherein the guide track is elongated from a first end toward an opposite second end, the first and second sidewalls extending from the first end to the second end, the retaining flange extends from the first end partially toward but not to the second end.

5. The retention guide assembly of claim 4, wherein the retaining flange extends partially toward the second end and provides an opening through which the roller is inserted into the internal recessed volume of the guide track.

6. The retention guide assembly of claim 1, wherein the retaining flange is positioned to engage a shoulder on a roller shaft on which the roller is disposed, the shoulder disposed between the control arm and the roller.

7. The retention and guide assembly of claim 1, further comprising a sensor coupled with the guide track and configured to detect at least a partial disengagement or mis-adjustment during installation or maintenance of one or more of the roller or the control arm from the guide track.

8. The retention and guide assembly of claim 7, wherein the sensor is coupled with the retaining flange of the guide track.

9. The retention and guide assembly of claim 7, wherein the sensor includes one or more of a piezoelectric strip, a magnetic switch, a capacitive or inductive proximity sensor, a friction strip, or a rubber sensitive edge extrusion.

10. A vehicle door retention and guide assembly comprising:
an elongated first sidewall configured to be connected to a door panel of a vehicle door;
an elongated second sidewall coupled with and oriented transverse to the first sidewall; and
an elongated retaining flange coupled with and oriented transverse to the second sidewall, each of the first sidewall, the second sidewall, and the retaining flange extending from a first end toward a second end, the first and second sidewalls extending from the first end to the second end, the retaining flange extending from the first end toward, but not entirely to, the second end,
the first sidewall, the second sidewall, and the retaining flange at least partially extending around and bounding an internal recessed volume,
the first sidewall, the second sidewall, and the retaining flange shaped to receive a roller of a control arm extending from a vehicle body between the first sidewall, the second sidewall, and the retaining flange, the retaining flange positioned to engage one or more of the control arm or the roller and retain the roller within the internal recessed volume between the second sidewall and the door panel of the vehicle door.

11. The retention and guide assembly of claim 10, wherein the first sidewall is configured to be connected to the door panel such that the second sidewall is oriented substantially parallel to a plane of the door panel and the retaining flange projects toward the door panel.

12. The retention and guide assembly of claim 10, wherein the retaining flange is spaced apart from the door panel while the first sidewall is connected with the door panel such that a roller shaft on which the roller is disposed is positioned between the door panel and the retaining flange.

13. A retention and guide assembly for a vehicle door, the assembly comprising:
a guide track configured to be connected to a door panel of the vehicle door, the guide track comprising sidewalls and an extension flange that at least partially extend around and define an internal recessed volume, the sidewalls including a first sidewall configured to be coupled with the door panel, a second sidewall that is coupled with and oriented transverse to the first sidewall and disposed away from the door panel, and a third sidewall that is coupled with and oriented transverse to the first sidewall and disposed to rest against a plane of the door panel, the extension flange configured to be coupled with and oriented transverse to the third sidewall, the sidewalls and the extension flange shaped to receive, within the internal recessed volume, a roller of a control arm extending from a vehicle body between the sidewalls and the extension flange, the extension flange configured to engage the control arm and retain the roller within the internal recessed volume of the guide track between the second sidewall and the door panel of the vehicle door.

14. The retention and guide assembly of claim 13, wherein the first sidewall of the guide track is configured to be connected to the door panel such that the second and third sidewalls are oriented substantially parallel to the door panel plane and the extension flange projects away from the door panel.

15. The retention and guide assembly of claim 13, wherein the extension flange is spaced apart from a lower tip of the second sidewall while the guide track is connected with the door panel such that a control arm on which a roller shaft and roller are disposed is positioned between the lower tip of the second sidewall and the extension flange.

16. The retention guide assembly of claim 13, wherein the guide track is elongated from a first end toward an opposite second end, the first, second and third sidewalls extending from the first end to the second end, the extension flange extending from the first end partially toward but not completely to the second end.

17. The retention guide assembly of claim 16, wherein the extension flange partially extends toward the second end to provide an opening through which the roller is inserted into the internal recessed volume of the guide track.

18. The retention and guide assembly of claim 13, further comprising:
a sensor coupled with the guide track and configured to detect at least a partial disengagement of one or more of the roller or the control arm from the guide track.

19. The retention and guide assembly of claim 18, wherein the sensor is coupled with the extension flange of the guide track.

20. The retention and guide assembly of claim 18, wherein the sensor includes one or more of a piezoelectric strip, a magnetic switch, a capacitive or inductive proximity sensor, or a friction strip.
